(19) United States
(12) Patent Application Publication
(10) Pub. No.: US 2017/0033585 A1
(43) Pub. Date: Feb. 2, 2017

(54) BATTERY SYSTEM RESET SYSTEMS AND RELATED METHODS

(71) Applicant: SEMICONDUCTOR COMPONENTS INDUSTRIES, LLC, Phoenix, AZ (US)

(72) Inventors: Mutsuki NIKI, Saitama-shi (JP); Keiji AMEMIYA, Fukaya-shi (JP); Yasuaki HAYASHI, Oura-gun (JP); Katsumi YAMAMOTO, Kokubunji (JP)

(73) Assignee: SEMICONDUCTOR COMPONENTS INDUSTRIES, LLC, Phoenix, AZ (US)

(21) Appl. No.: 14/814,662

(22) Filed: Jul. 31, 2015

(51) Int. Cl. H02J 7/00

(52) U.S. Cl. CPC H02J 7/0072; H02J 7/0029; H02J 7/0042

(57) ABSTRACT

A battery reset system. Implementations may include: an embedded battery, a battery control circuit coupled with the embedded battery, a discharging field effect transistor (FET) coupled with the battery control circuit, and a charging FET coupled with the battery control circuit. The system may also include a positive battery terminal coupled with the battery and a negative battery terminal coupled with the embedded battery and a reset terminal coupled with a reset circuit coupled with the battery control circuit. The reset circuit and the battery control circuit may be included in a single semiconductor chip coupled with the discharging FET, charging FET, and embedded battery.

### BACKGROUND

1. Technical Field

Aspects of this document relate generally to battery systems, such as batteries for portable devices.

2. Background Art

Battery systems have been devised to allow electronic devices to operate independent of power from a main power supply. Often, these take the form of a battery pack that contains control circuitry for the battery and which includes a set of leads which electrically couple the battery back to the electronic device. Examples of conventional systems and devices may be found in Japan Patent Application Publication No. P2008-192959A to Masanori Kobayashi, entitled “Semiconductor Integrated Circuit,” filed Feb. 7, 2007 and published Aug. 21, 2008; Japanese Patent Application Publication No. P2009-131020A to Masatoshi Sugimoto, entitled “Over-Current Protecting Circuit and Battery Pack,” filed Nov. 22, 2007 and published Jun. 11, 2009; and Japanese Patent Application Publication No. P2009-283507A to Yamaguchi et al. entitled “Voltage Setting Circuit, Method for Setting Voltage, Secondary Battery Protecting Circuit, and Semiconductor Integrated Circuit Device,” filed May 19, 2008 and published Dec. 3, 2009; the disclosures of each of which are hereby incorporated entirely herein by reference.

### SUMMARY

Implementations of embedded battery systems may include: an embedded battery, a battery control circuit coupled with the embedded battery, a discharging field effect transistor (FET) coupled with the battery control circuit, and a charging FET coupled with the battery control circuit. The system may also include a positive battery terminal coupled with the battery and a negative battery terminal coupled with the embedded battery and a reset terminal coupled with a reset circuit coupled with the battery control circuit. The reset circuit and the battery control circuit may be included in a single semiconductor chip coupled with the discharging FET, charging FET, and embedded battery.

Implementations of embedded battery systems may include one, all, or any of the following:

No other FETs may be included except the discharging FET and charging FET.

The reset circuit may be configured to turn off at least the discharging FET in response to receiving a reset signal from the reset terminal.

A hardware switch may be included which is configured to be pressed by a user and is coupled with the reset terminal and configured to send a reset signal to the reset circuit when pressed by the user for a predetermined period of time.

The reset circuit may be configured to receive a reset signal via the reset terminal from a load or a charger coupled to the battery.

The reset circuit may be configured to receive a reset signal via the reset terminal when an external power signal is applied to the reset terminal.

The external power signal may be sent from a power module integrated circuit (IC) coupled with the positive battery terminal and the negative battery terminal. The reset circuit may be configured to test the operation of the embedded battery through turning off at least the discharging FET.

The system may further include a test switch and a reset switch where when the test switch is closed, the reset terminal is configured to allow a testing system to test the embedded battery system, and when the reset switch is closed, the reset terminal is configured to receive reset signals and forward them to the reset circuit.

The test switch may be configured to close in response to receiving a testing current sense signal, a testing voltage signal, or both a testing current sense signal and a testing voltage signal at the positive battery terminal where the testing current sense signal or the testing voltage signal may be configured to be above an overcharge voltage level for the embedded battery.

The system may further include a fuse array, a reset logic circuit configured to turn off at least the discharging FET in response to receiving a reset signal from the reset terminal, and at least one testing fuse coupled with the fuse array and reset logic circuit and may be configured to move a test/reset switch from a testing position to a reset position upon receiving a testing fuse trimming signal and an end of a testing sequence of the embedded battery system.

Implementations of a battery control system for an embedded battery may include a battery control circuit configured to be coupled with an embedded battery, a discharging FET coupled with the battery control circuit, and a charging FET coupled with the battery control circuit. The system may also include a positive battery terminal coupled with the battery and a negative battery terminal coupled with the battery control circuit and a reset terminal coupled with a reset circuit coupled with the battery control circuit. The reset circuit and battery control circuit may be included in a single semiconductor chip coupled with the discharging FET and charging FET.

Implementations of battery control systems may include one, all, or any of the following:

No other FETs may be included except the discharging FET and charging FET.

The reset circuit may be configured to turn off at least the discharging FET in response to receiving a reset signal from the reset terminal.

A hardware switch may be included which is configured to be pressed by a user and coupled with the reset terminal and configured to send a reset signal to the reset circuit when pressed by the user for a predetermined period of time.

The reset circuit may be configured to receive a reset signal via the reset terminal from a load or a charger coupled to the battery control circuit.

The reset circuit may be configured to receive a reset signal via the reset terminal when an external power signal is applied to the reset terminal.

The external power signal may be sent from a power module IC coupled with the positive battery terminal and the negative battery terminal. The reset circuit may be configured to test the operation of the embedded battery through turning off at least the discharging FET.

The system may further include a test switch and a reset switch where when the test switch is closed, the reset terminal is configured to allow a testing system to test the embedded battery system, and when the reset switch is closed, the reset terminal is configured to receive reset signals and forward them to the reset circuit.

The test switch may be configured to close in response to receiving a testing current sense signal, a testing voltage signal or both a testing current sense signal and a testing voltage signal at the positive battery terminal where the testing current sense signal or the testing voltage are configured to be above an overcharge voltage level for the embedded battery.

The system may include a fuse array, a reset logic circuit configured to turn off at least the discharging FET in response to receiving a reset signal from the reset terminal, and at least one testing fuse coupled with the fuse array and reset logic circuit and may be configured to move a test/reset switch from a testing position to a reset position upon receiving a testing fuse trimming signal and an end of a testing sequence of the embedded battery system.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a circuit diagram of a conventional battery system including a reset integrated circuit (IC);

FIG. 2 is a circuit diagram of a first implementation of a battery reset system;

FIG. 3 is a circuit diagram of a second implementation of a battery reset system;

FIG. 4 is a signal diagram of the reset signal and field effect transistor (FET) activity for the system of FIG. 3;

FIG. 5 is a circuit diagram of an implementation of a battery reset circuit used for the system implementation illustrated in FIG. 3;

FIG. 6 is a circuit diagram of a third implementation of a battery reset system;

FIG. 7 is a signal diagram of the reset signal and FET activity for the system of FIG. 6;

FIG. 8 is a circuit diagram of an implementation of a battery reset circuit used for the system implementation illustrated in FIG. 6;

FIG. 9 is a circuit diagram of a fourth implementation of a battery reset system;

FIG. 10 is signal diagrams of the reset signal and FET activity for the system of FIG. 9;

FIG. 11 is a circuit diagram of an implementation of a battery reset circuit used for the system implementation illustrated in FIG. 9;

FIG. 12 is a circuit diagram of an implementation of a battery reset system having a testing terminal;

FIG. 13 is a circuit diagram of an implementation of a battery reset system having a testing switch and reset switch to permit the reset terminal to be used temporarily as a testing terminal;

FIG. 14 is a circuit diagram of a first implementation of a battery reset circuit that may be used for the system implementation of FIG. 13;

FIG. 15 is a circuit diagram of a second implementation of a battery reset circuit that may be used for the system implementation of FIG. 13;

FIG. 16 is a circuit diagram of a third implementation of a battery reset circuit that may be used for the system implementation of FIG. 13;

FIG. 17 is a circuit diagram of a fourth implementation of a battery reset circuit that may be used for the system implementation of FIG. 13;

FIG. 18 is an exemplary signal diagram of the normal reset operation of the system implementation of FIG. 13;

FIG. 19 is an exemplary signal diagram of the testing operation of the system implementation of FIG. 13;

FIG. 20 is a circuit diagram of an implementation of a battery reset system having a testing terminal;

FIG. 21 is a circuit diagram of an implementation of a battery reset system having a fuse array, reset logic, and at least one fuse designed to move a switch from a testing position to a reset position to allow the reset terminal to be used temporarily as a testing terminal;

FIG. 22 is a circuit diagram of an implementation of a battery reset circuit that may be used in the system implementation of FIG. 21.

### DESCRIPTION

This disclosure, its aspects and implementations, are not limited to the specific components, assembly procedures or method elements disclosed herein. Many additional components, assembly procedures and/or method elements known in the art consistent with the intended battery reset systems will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such battery reset systems, and implementing components and methods, consistent with the intended operation and methods.

Various system and circuit implementations disclosed herein are used with batteries incorporated with various control circuitry (“battery pack”), particularly with embedded batteries. As used herein, “embedded” means the battery is not physically removable by a user following assembly of the electronic device in which the battery has been incorporated. Because of this characteristic of embedded batteries, it is not possible to for the user to do what can be done with conventional removable batteries to reset the battery pack and/or device to which the battery pack is coupled by simply removing the battery pack and reinstalling it. The effect of removing the conventional battery pack disconnects the load and/or charger from the pack and causes the battery pack system to implement an internal reset. Embedded batteries requiring reset cannot be removed, but must be reset while still internal to the electronic device.

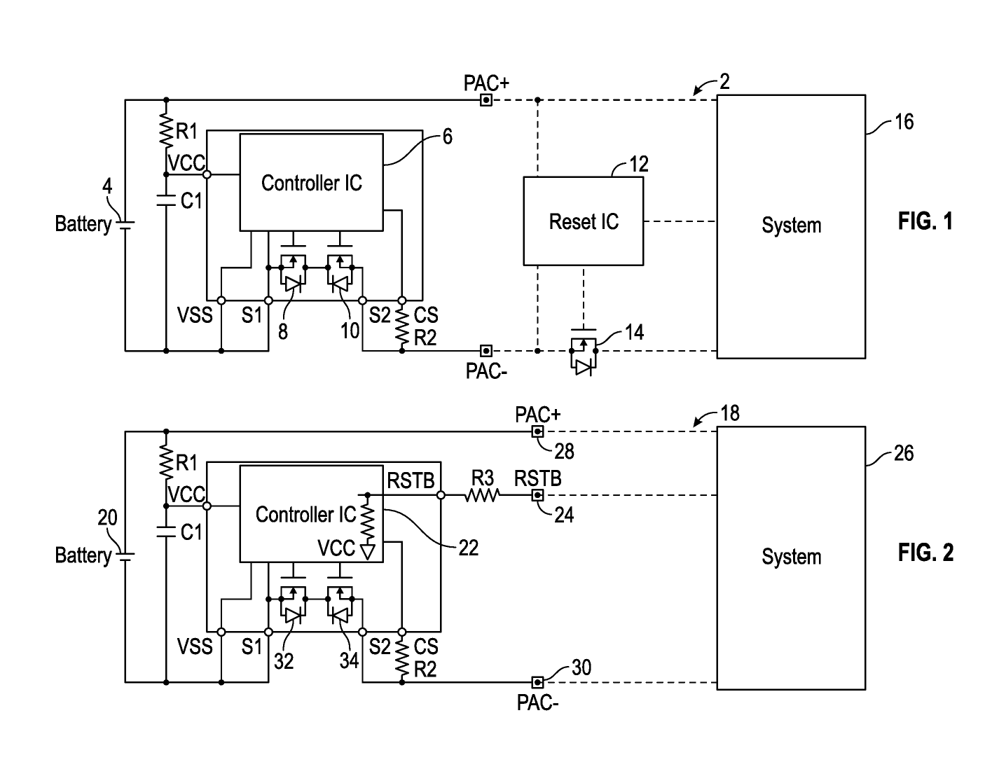

Referring to FIG. 1, an implementation of a conventional battery reset system 2 is illustrated. As illustrated, the system includes a battery 4 to which a controller integrated circuit (IC) 6 is coupled along with a discharging field effect transistor (FET) 8 and a charging FET 10. The system 2 also includes a reset IC 12 which is coupled with reset FET 14 across the terminals of the battery 4. Reset IC 12 is designed to detect problems with the battery 4 or with the system 16 (whether load or charger) and use reset IC 12 to stop the flow of current from the battery 4, thereby causing controller IC 6 to believe the battery 4 has been disconnected from the system 16. This allows the entire system to begin a reset process, including the discharging FET 8 and charging FET 10. As illustrated, reset IC 12 is a separate semiconductor device from the controller IC 6, and the reset FET 14 is an additional FET to the discharging FET 8 and charging FET 10. Because of this, additional complexity and impedance may result, which can cause overheating of the battery pack and increase the cost of the embedded battery system.

Referring to FIG. 2, a first implementation of a battery reset system 18 is illustrated. As illustrated, the system includes a battery 20 coupled to a controller IC 22 that includes a reset circuit (not shown) that is incorporated in the same semiconductor chip as the controller IC 22. The reset circuit is coupled with a reset terminal 24 that is in communication with system 26. The system 18 also includes a positive battery terminal 28 and a negative battery terminal 30, meaning that the system 18, unlike the system 2 in FIG. 1 has three terminals rather than two. The system 18, because of the reset circuit being incorporated on the same chip as the controller IC 22, does not include a separate reset IC on a separate semiconductor chip or a reset FET, just a discharging FET 32 and charging FET 34. The reset circuit is design to turn off at least the discharging FET 32, via the controller IC 22, in response to receiving a reset signal from the reset terminal. By shutting off at least the discharging FET 32, the reset circuit is able to shut off the root of the current. In other implementations, the reset circuit may shut off both the discharging FET 32 and the charging FET 34, or may shut off the just the charging FET 34. By shutting down the discharging FET 32, the battery 4 is disconnected from the system 26 and this simulates the situation where the embedded battery 4 was physically removed from the system 26, and causes the controller IC 22 to perform a reset process.

Various implementations of battery reset systems and battery reset circuits that use a reset terminal are disclosed in this document, along with various structures and methods for sending a reset signal to the reset terminal. These systems are designed for embedded batteries, though in various implementations, the systems could be employed with user physically removable batteries as well.

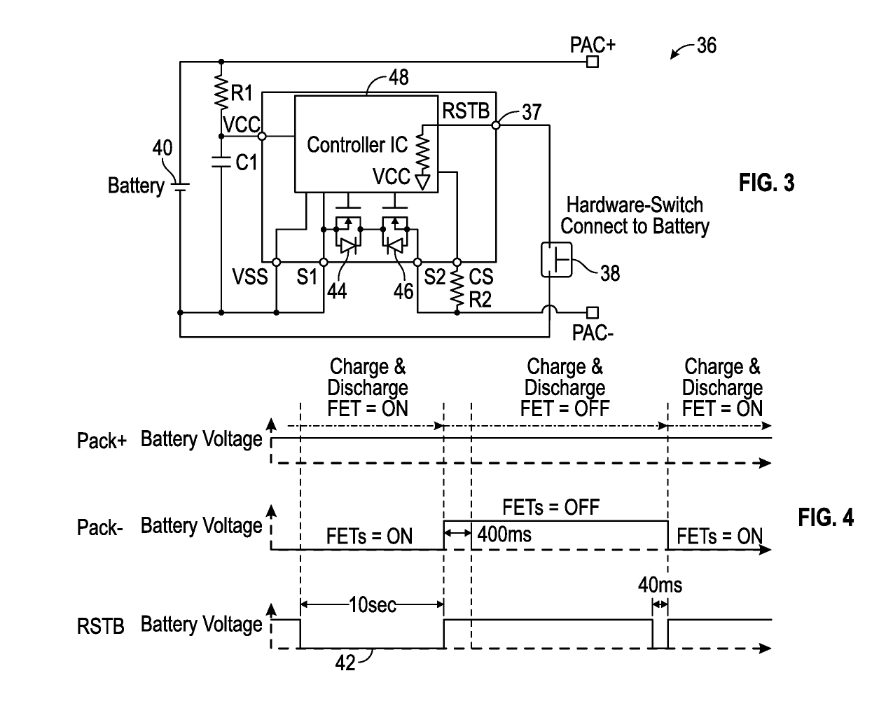

Referring to FIG. 3, a second implementation of a battery reset system 36 is illustrated. As illustrated, the reset terminal 37 RSTB is coupled to a hardware switch 38. This hardware switch 38 is a physical switch on the electronic device in which the battery 40 is embedded which is accessible to a user to press on/engage. FIG. 4 illustrates a signal diagram that shows the reset signal 42 and discharging and charging FET 44, 46 activity in response to the action of the reset circuit that receives the reset signal 42 via the reset terminal 37. As can be seen from FIG. 4, the user needs to press on/engage the hardware switch 38 for a predetermined period of time (in this case, 10 seconds, though this time could be longer or shorter) before the reset signal 42 is sent to the reset circuit which then, through the controller IC 48, turns off both FETs 44, 46. The user then is able to press on/engage the hardware switch 38 for a period of time (which may be predetermined in some implementations, or merely momentary) which then causes the reset signal 42 to again be sent through the reset terminal 37 to the reset circuit which then via the controller IC 48 turns back on the FETs 44, 45. This then allows the embedded battery 40 to provide power to the load or receive power from a charger.

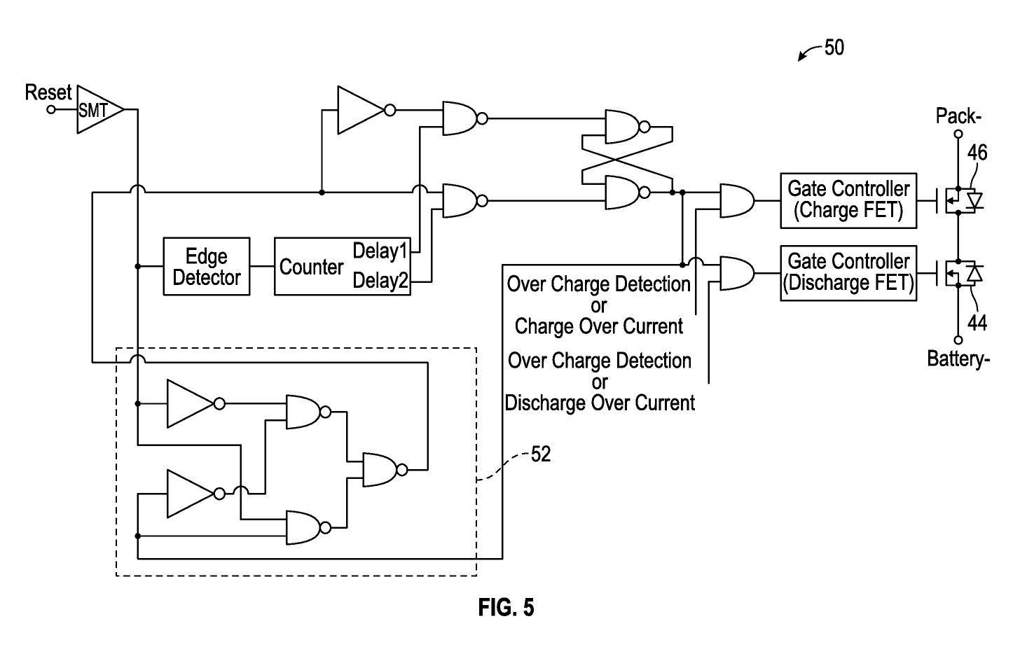

Referring to FIG. 5, an implementation of a reset circuit 50 that may be employed in the battery reset system 36 of FIG. 3 is illustrated. As illustrated, the circuit 50 includes a delay circuit 52 in the circuit that is used to allow the reset circuit 50 to wait the predetermined period of time before sending a reset signal to the controller IC 48. The controller IC 48 includes gate controllers of the discharging FET 44 and charging FET 46. The gate controllers then turn off and turn on the FETs 44, 46 in response to the signal from the reset circuit 50.

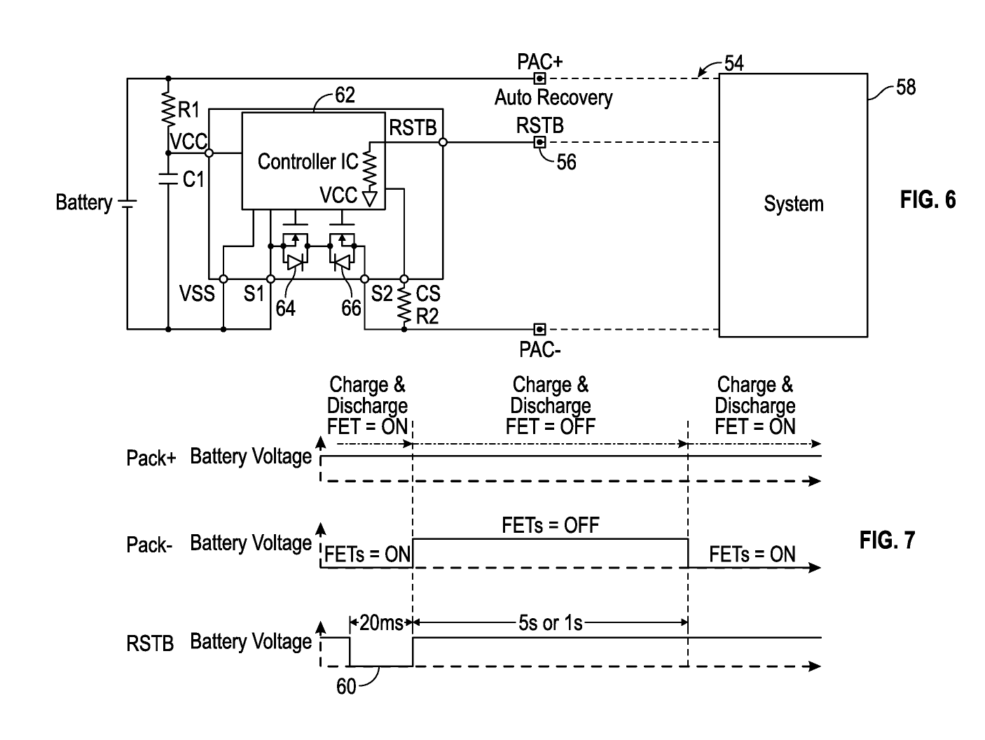

Referring to FIG. 6, a third implementation of a battery reset system 54 is illustrated. In this system 54 implementation, the reset terminal 56 is in contact with the system 58. The system 58 is designed to send the reset signal 60 directly to the reset terminal 56, which then forwards the signal to the reset circuit. The reset circuit then, which is incorporated on the controller IC 62, via the controller IC 62, then shuts off the discharging FET 64 and charging FET 66. FIG. 7 is an exemplary signal diagram that shows the reset signal 60 and the shutoff period for the FETs 64, 66. In this implementation, since the reset signal 60 is sent automatically (or via user interaction with the system 58), the FETs 64, 66 are designed to restart after predetermined period of time (in this example, about 1 second or about 5 seconds). In other implementations, however, the FET restart may be initiated by the reset circuit itself, the controller IC 62, or a user interaction with the system 58.

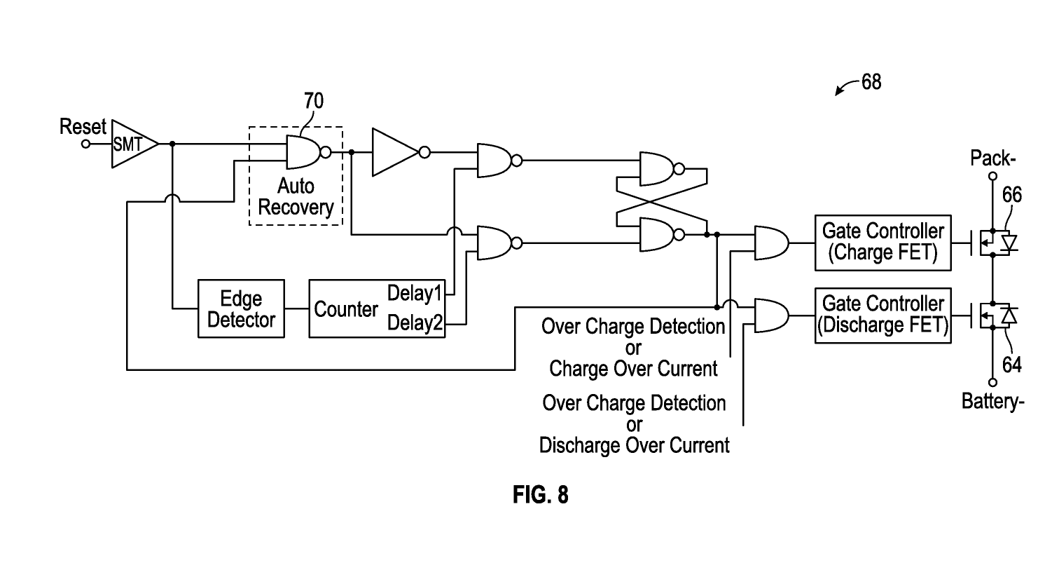

Referring to FIG. 8, an implementation of a reset circuit 68 that may be used in the battery reset system 54 implementation illustrated in FIG. 6 is illustrated. As illustrated, the circuit 68 includes an AND gate 70 which allows the circuit 68 to automatically, after a period of time, send a signal to the gate controllers of the discharge FET 64 and charge FET 66 to turn the FETs back on. As with the previous system implementation, the controller IC 62 includes the gate controllers.

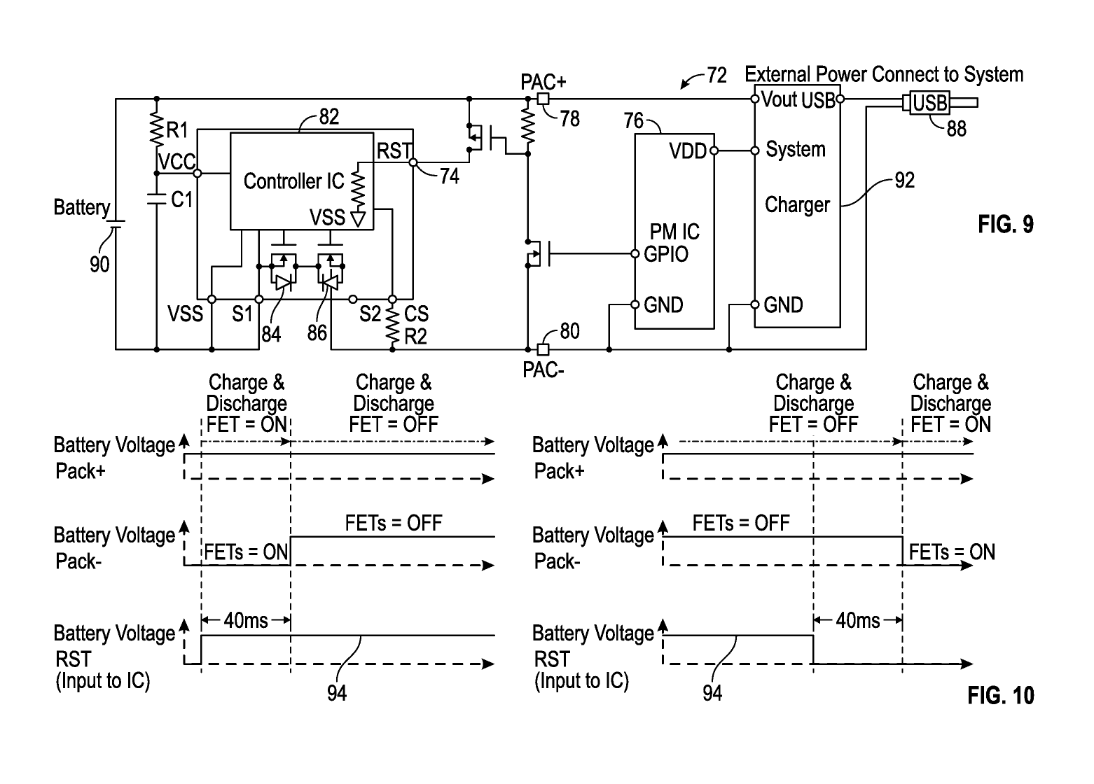

Referring to FIG. 9, a fourth implementation of a battery reset system 72 is illustrated. In this system 72, the reset terminal 74 is coupled with a power module IC 76 which is also coupled with the positive battery terminal 78 and negative battery terminal 80 and with an external power source 88. The power module IC 76 generates an external power signal which is received by the reset terminal 74 and transferred to the reset circuit incorporated in the controller IC 82. The reset circuit via the controller IC 82 the shuts down at least the discharge FET 84, which disconnects the battery from the external power source 88. Since the electronic device is still receiving power from the external power source 88, the purpose of disconnecting the battery 90 upon connection of an external power source 88 is to test the operation of the battery 90 and verify whether it is leaking power, etc. This particular reset circuit and system 92 design may be used following manufacturing of the battery system and just prior to shipping. By disconnecting the battery 90 from the power source when it is connected, the operation of the battery 90 and other components in the battery reset system 72 can be evaluated using the system 92 and bad batteries detected.

In other implementations, the battery disconnection may be useful to avoid overcharging/overdischarging of the battery while it is connected to external power and charging or while the system device is operating exclusively or partially on external power. As illustrated, the external power source in the system 72 of FIG. 9 is a universal serial bus (USB) connector, but any other power connector/jack/supply type could also be used in various implementations. FIG. 10 shows two signal diagrams that demonstrate the reset signal 94 activating upon the reset circuit's receiving the external power signal via the reset terminal 74 and acting with the controller IC 82 to shut off at least the discharging FET 84. The FETs then stay off until the external power signal is removed from the reset terminal 74, which then causes the reset circuit to act with the controller IC 82 to turn the FETs back on, so that the battery system is ready to supply power once again.

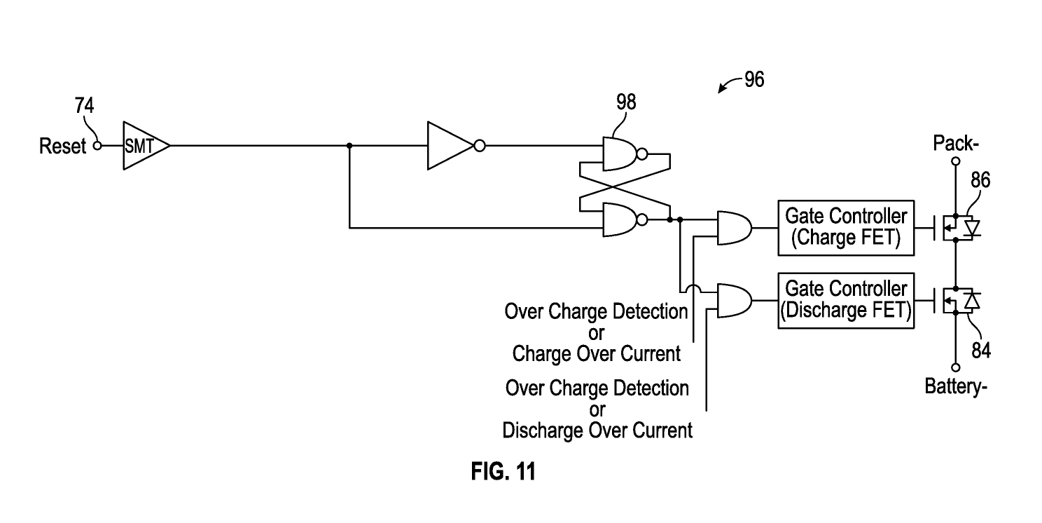

Referring to FIG. 11, an implementation of a reset circuit 96 is illustrated that may be included in the battery reset system 72 of FIG. 9. As illustrated, the circuit 96 acts to store a reset state when the external power signal is received at the reset terminal 74 and then change that state when the external power signal is removed from the reset terminal 74. Latch 98 is used store the reset signal and to signal the change of the reset signal at removal of the external power signal to the gate controllers of the FETs 84, 86 to turn them off and on via the controller IC 82.

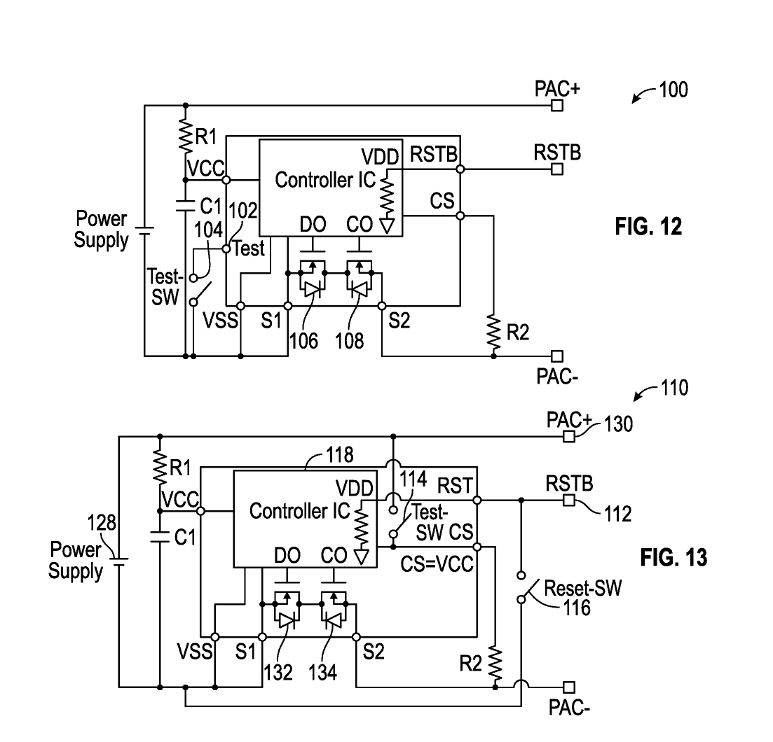

Referring to FIG. 12, an implementation of a battery reset system 100 that includes a testing terminal 102 and reset terminal 103 which may operate according to any of the various circuits. During testing of the system 100 prior to shipping, test switch 104 is closed, and various testing signals are passed through and received through the testing terminal 102. Because the testing terminal 102 is accessible outside the semiconductor package that includes the controller IC (and in various implementations, the FETs 106, 108 as well), the size of the package and the cost of manufacture are accordingly increased.

FIG. 13 illustrates a battery reset system 110 implementation that is designed to allow the reset terminal 112 to temporarily act as a testing terminal and then be repurposed again to receive reset signals. As illustrated, the system 110 includes a test switch 114 and a reset switch 116. When the test switch 114 is closed the reset terminal 112 is configured to receive testing signals from a testing system coupled to the reset terminal 112. When the reset switch is closed, the reset terminal 112 is configured to receive reset signals and forward them to the reset circuit in the controller IC 118.

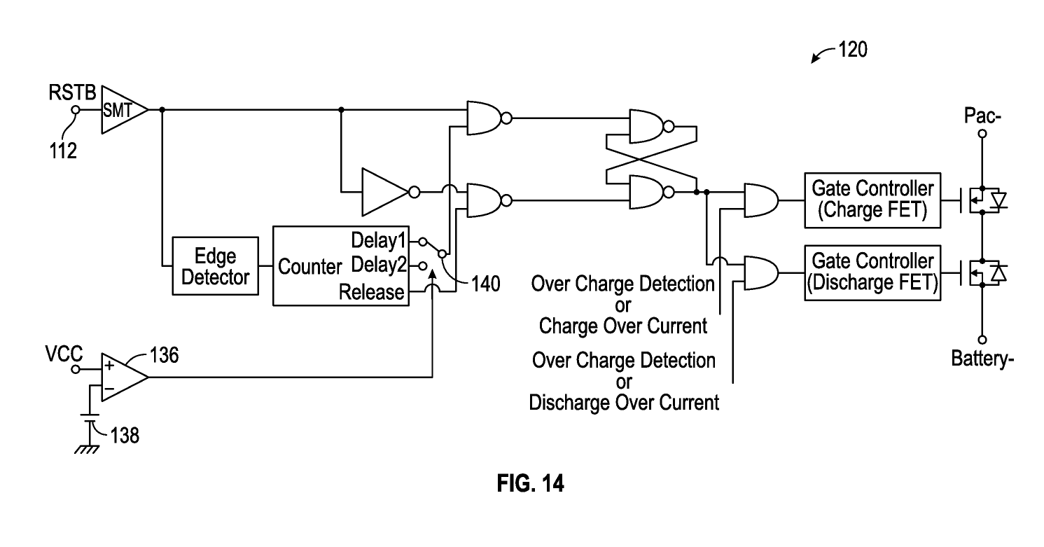

Referring to FIGS. 14-17, four different implementations of reset circuits 120, 122, 124, 126 are illustrated that each may be used in the battery reset system 110 implementation illustrated in FIG. 13. The way that the test switch 114 is closed/triggered in the various system 110 implementations is by receiving a testing current sense signal and/or a testing voltage signal at the positive battery terminal 130. This testing current sense signal, which as can be seen in FIG. 13 is equated to the supply voltage (Vcc) signal during testing, indicates that a voltage above an overcharge voltage level for the battery (power supply) 128 has been applied to the positive battery terminal 130. When this occurs, the controller IC 118's battery protection functions will activate, causing the discharging FET 132 and charging FET 134 to shut down. The test switch 114, which may, in various implementations, be externally installed onto the battery pack, is then closed which shorts the current sense signal with the supply voltage signal. This configuration allows the external testing system to communicate with the controller IC 118 through the reset terminal 112 and communicating testing signals to the controller IC 118 and the FETs 132, 134. Following testing, the current sense signal is unshorted with the supply voltage signal and the test switch 114 opened, and, in particular implementations, removed from being coupled with the battery reset system 110. For a one cell lithium ion battery, the maximum voltage is about 4.2 V to 4.3 V. Accordingly, if a voltage of about 5 V or more is applied to the positive battery terminal 130 of such a battery to initiate testing, the controller IC 118 is designed to recognize this as an overcharge voltage level which would not ordinarily result absent a charger malfunction.

The reset circuits 120, 122, 124, 126 are all designed to interpret the overcharge voltage signal and activate the test switch 114 and the reset switch 116 and handle the signal which has been designed to look abnormal. These circuits may permit quicker testing using a triggered application of the voltage. In various implementations, the test switch 114 and reset switch 116 may be the same switch with a testing position and reset position. Referring to FIG. 14, a comparator 136 with an input of supply voltage measured versus a fixed reference voltage 138 versus ground is used to detect the presence of the overcharge voltage signal applied to the positive battery terminal 130 and send a signal to test switch 140 so it changes position so that testing signals can be applied to reset terminal 112. When the overcharge voltage signal is released from the positive battery terminal 130, a signal is generated by the comparator 136 that causes the test switch 140 to move back into position to allow the reset terminal 112 to receive and process reset signals.

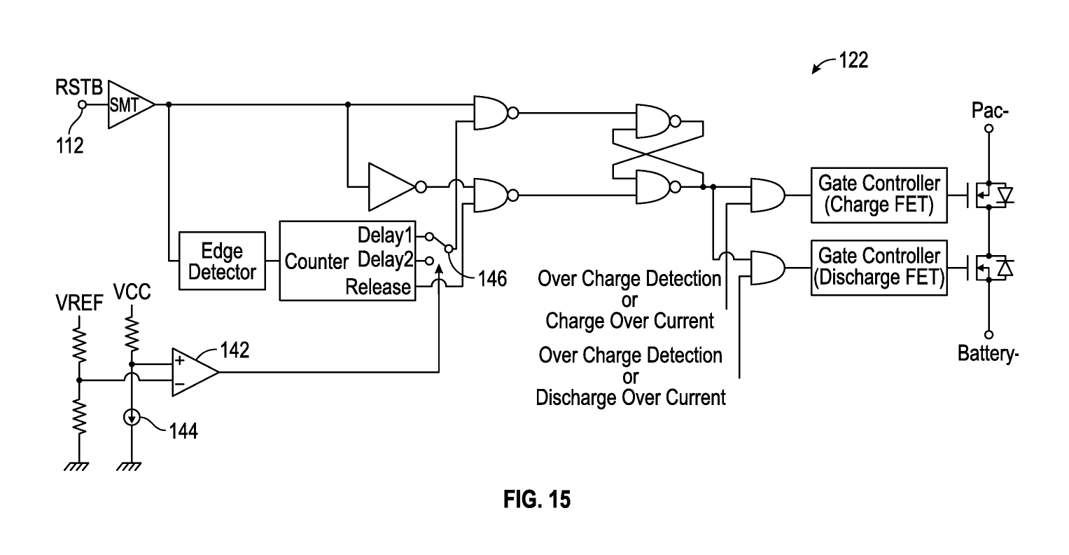

Referring to FIG. 15, a comparator 142 is used and receives a voltage input formed from the supply voltage signal Vcc being coupled with a constant current source 144 and is compared with a reference voltage Vref. When the overcharge voltage signal is received at the positive terminal of the battery 130, the comparator 142 generates an output the changes the position of test switch 146; when the overcharge voltage signal is released, the output of the comparator 142 changes the position of test switch 146 once again to allow reset terminal 112 to receive and process reset signals.

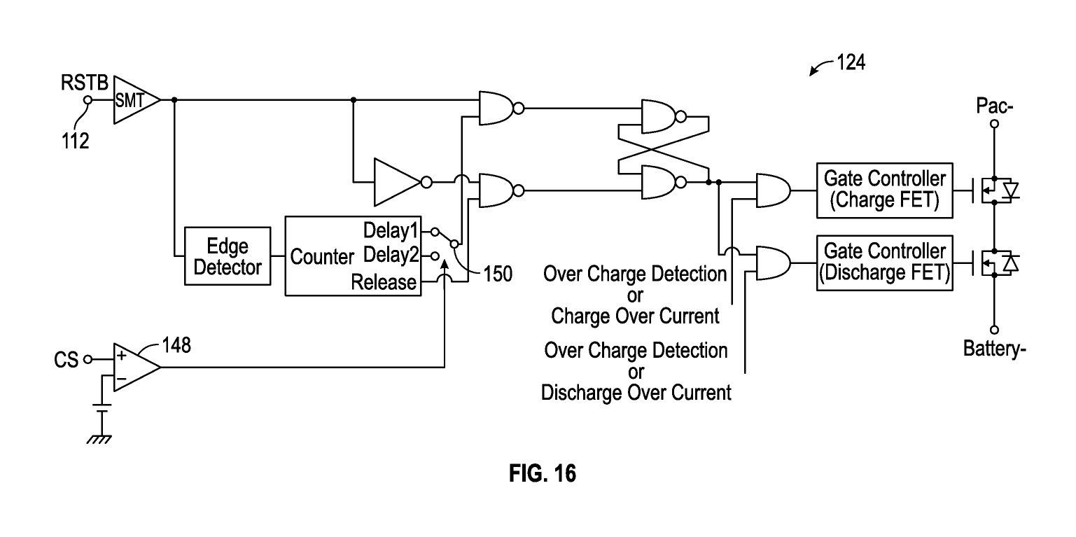

Referring to FIG. 16, a comparator 148 is design to take the current sense (CS) signal and measure it against a known voltage measured against ground. When the overcharge voltage signal is applied to the positive battery terminal 130, since this will result in a rise in the current sense signal as well, the comparator 148 sends an output to safety switch 150 to have it change position to a testing position. When the current sense signal returns to its normal position, the safety switch 150 shifts position through the comparator 148 output to a position where the reset terminal 112 can forward reset signals to the reset circuit 124.

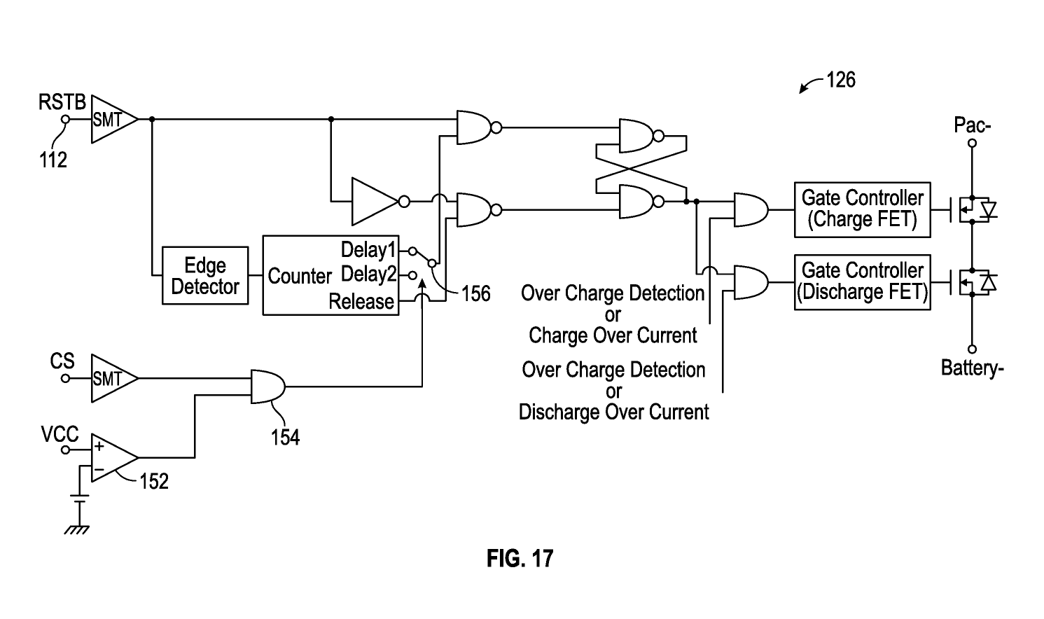

FIG. 17 illustrates a reset circuit 126 implementation where a combination of the current sense signal and the output of a comparator 152 receiving a supply voltage and a reference voltage relative to ground are combined through AND gate 154. Provided both the current sense signal and the supply voltage signal the application of an overcharge voltage to the positive battery terminal 130, then the safety switch 156 changes position to allow the reset terminal 112 to receive testing signals. When one or both of the current sense signal and the supply voltage signal change to signal a non-overcharge condition, then the comparator 154 outputs a signal that changes the position of the safety switch 156 to allow reset signals applied to the reset terminal 112 to be processed by the reset circuit 126.

A wide variety of possible reset circuit designs using the principles disclosed in this document and those references incorporated by reference herein are possible.

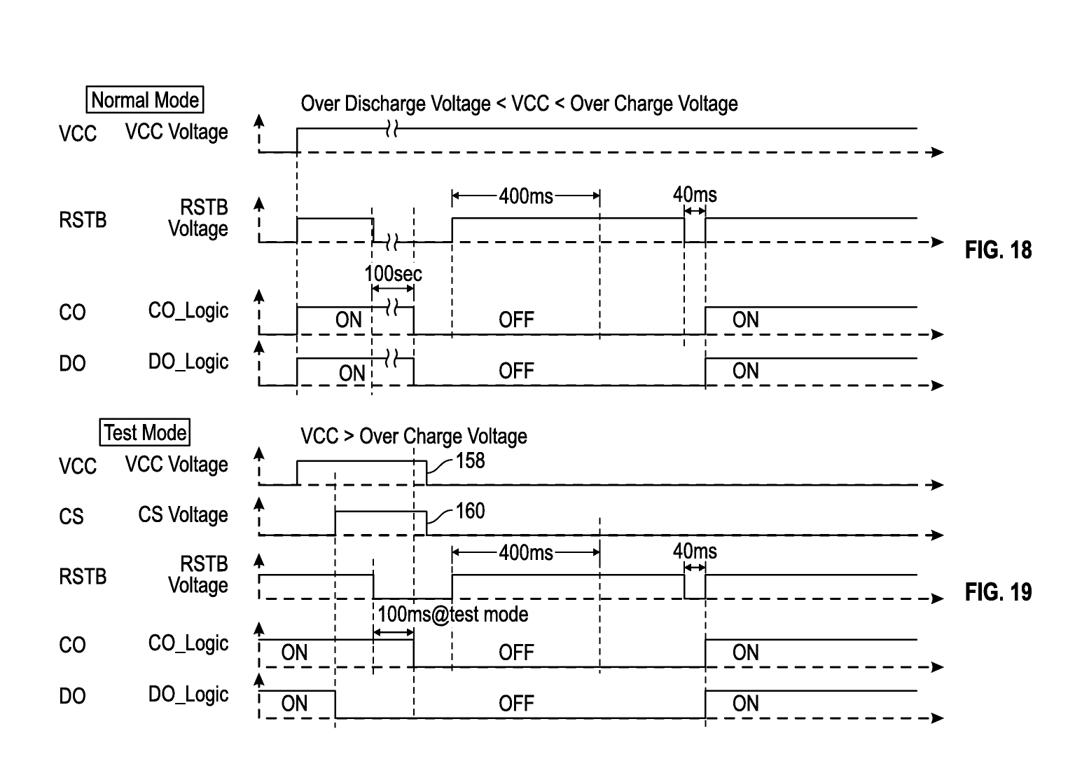

Referring to FIG. 18, a signal diagram showing the normal processing of reset signals and charging FET and discharging FET signals for the implementation of a battery reset system in FIG. 13 is illustrated. As illustrated, in this situation, the supply voltage Vcc is kept in a normal range between the over discharge voltage level and the overcharge voltage level. This can be compared to the situation illustrated in FIG. 19, which shows the supply voltage and current sense signal where a testing voltage signal 158 and a testing current sense signal 160 are applied to the positive battery terminal 130. As can be seen, this signal shuts off the FETs and allows the reset voltage signal to be used as a testing signal through the rest terminal 112.

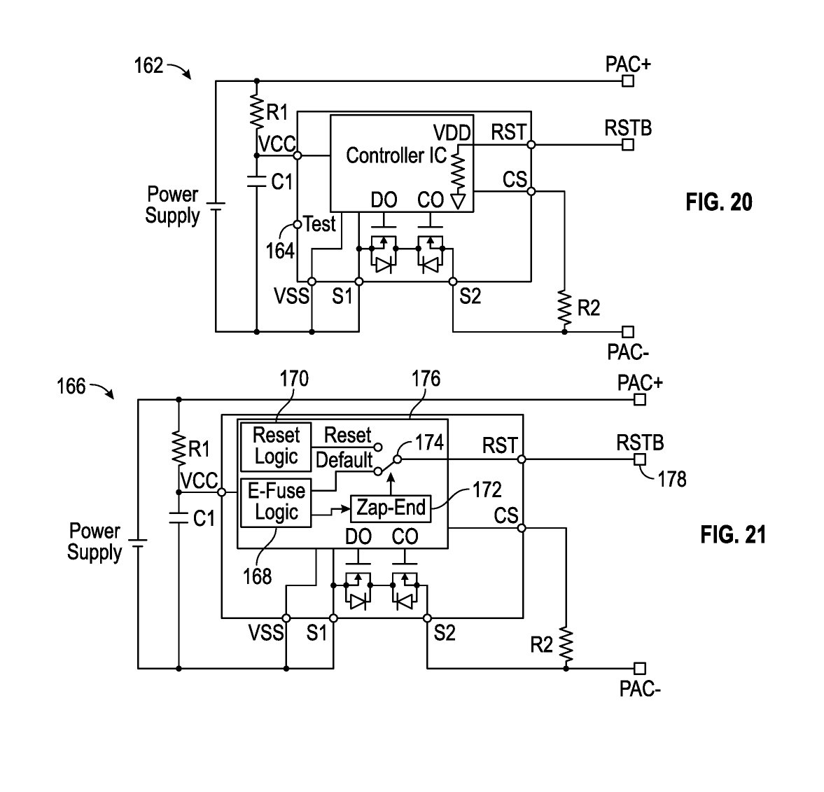

Referring to FIG. 20, another implementation of a battery reset system 162 is illustrated that has a test terminal 164. Like the implementation illustrated in FIG. 12, the test terminal 164 adds additional structure and accordingly package size and expense when it is to be used likely only once in the lifecycle of the system 162. FIG. 21 illustrates a battery reset system 166 that includes a fuse array 168 designed to be used during operation of the controller IC 176. This fuse array 168 and the systems and methods of using the same may be any described in copending U.S. patent application Ser. No. 14/809,425 to Saito, et al., entitled “Programmable Battery Protection System and Related Methods,” filed Jul. 27, 2015; copending U.S. patent application Ser. No. 14/811,973 to Saito, et al., entitled “Automatically Programmable Battery Protection System and Related Methods,” filed Jul. 29, 2015; copending U.S. patent application Ser. No. 14/813,314 to Amemiya, et al., entitled “Automatically Programmable Battery Protection System and Related Methods,” filed Jul. 30, 2015; copending U.S. patent application Ser. No. 14/814,305 to Hayashi, et al., entitled “Battery Protection System with Reference Voltage Control System,” filed Jul. 30, 2015, (the “Fuse Applications”) the disclosures of each of which are hereby incorporated entirely herein by reference. The fuse array 168 is coupled to a test/reset switch 174 which is design to toggle the connection between the reset terminal 178 and the fuse array 168 and a reset logic circuit 170. The reset logic circuit 170 may be any of the reset circuit implementations disclosed in this document or the references incorporated herein. By default, the test/reset switch 174, is in the testing position, connecting the reset terminal 178 with the fuse array 168. In this position, testing signals can be sent through the reset terminal 178 and used to generate data to be stored in the fuse array 168. When the data has been stored in the fuse array 168 using any of the methods in the Fuse Applications, a Zap-End testing fuse trimming signal is sent to at least one testing fuse 172, which, when opened, moves the test/reset switch 174 to the reset position. In various implementations, the test/reset switch 174 is now permanently at the reset position, though in some, the switch could be toggled back to the test position.

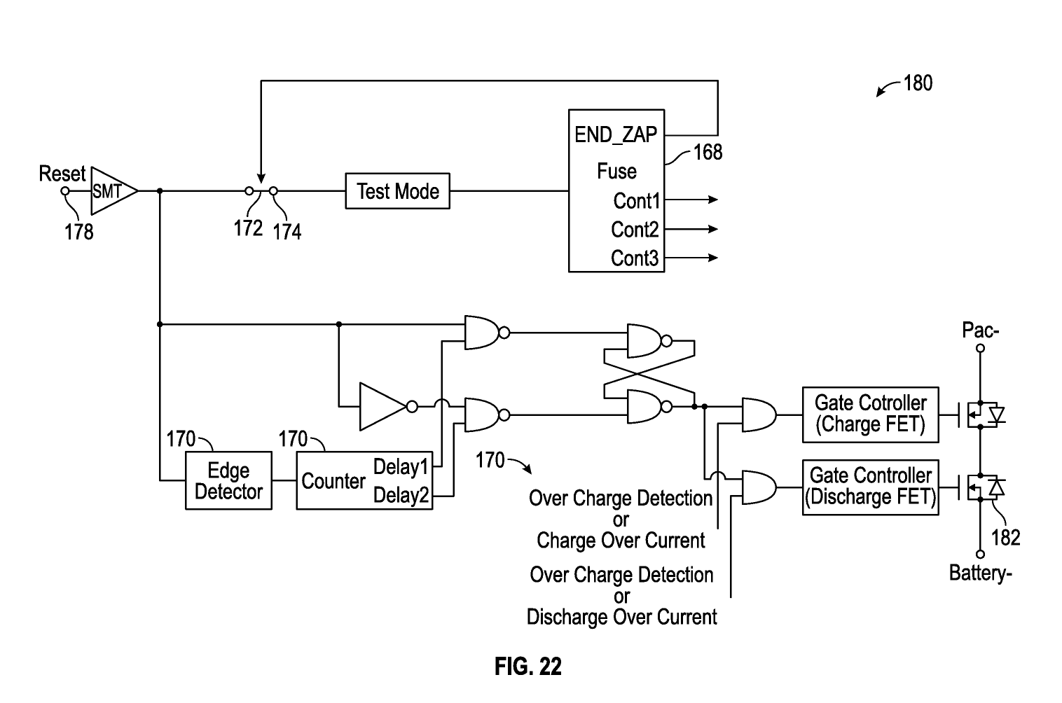

In the reset position, the test/reset switch 174 allows reset signals received at the reset terminal 178 to be processed by the reset logic 170 as disclosed in this document. By using the testing fuse 172, the reset terminal 178 can be used temporarily as a testing terminal and then repurposed as a reset terminal 178 permanently at the end of the testing sequence. FIG. 22 illustrates an implementation of a portion of a controller IC 180 that shows the fuse array 168, the testing/reset switch 174, the testing fuse 172, and the reset logic circuit 170. This circuit shows how, when the testing fuse 172 is opened by the END_ZAP testing signal, the testing circuitry is permanently unavailable, and all signals coming to the reset terminal 178 now go to reset logic circuit 170. These signal can now be used by the reset logic circuit 170 to open or close at least the discharge FET 182 via the gate controller of the controller IC 176 as disclosed herein.

In places where the description above refers to particular implementations of battery reset systems and implementing components, sub-components, methods and sub-methods, it should be readily apparent that a number of modifications may be made without departing from the spirit thereof and that these implementations, implementing components, sub-components, methods and sub-methods may be applied to other battery reset systems.

What is claimed is:

1. An embedded battery system comprising:
an embedded battery;
a battery control circuit coupled with the embedded battery;
a discharging field effect transistor (FET) coupled with the battery control circuit;
a charging FET coupled with the battery control circuit;
a positive battery terminal coupled with the battery and a negative battery terminal coupled with the embedded battery;
a reset terminal coupled with a reset circuit coupled with the battery control circuit;
wherein the reset circuit and battery control circuit are comprised in a single semiconductor chip coupled with the discharging FET, charging FET, and embedded battery.

2. The system of claim 1, wherein no other FETs are included except the discharging FET and charging FET.

3. The system of claim 1, wherein the reset circuit is configured to turn off at least the discharging FET in response to receiving a reset signal from the reset terminal.

4. The system of claim 3, wherein a hardware switch configured to be pressed by a user is coupled with the reset terminal and configured to send a reset signal to the reset circuit when pressed by the user for a predetermined period of time.

5. The system of claim 3, wherein the reset circuit is configured to receive a reset signal via the reset terminal from one of a load and a charger coupled to the battery.

6. The system of claim 3, wherein the reset circuit is configured to receive a reset signal via the reset terminal when an external power signal is applied to the reset terminal.

7. The system of claim 6, wherein the external power signal is sent from a power module integrated circuit (IC) coupled with the positive battery terminal and the negative battery terminal and wherein the reset circuit is configured to test the operation of the embedded battery through turning off at least the discharging FET.

8. The system of claim 1, further comprising a test switch and a reset switch, wherein when the test switch is closed, the reset terminal is configured to allow a testing system to test the embedded battery system, and when the reset switch is closed, the reset terminal is configured to receive reset signals and forward them to the reset circuit.

9. The system of claim 8, wherein the test switch is configured to close in response to receiving one of a testing current sense signal, a testing voltage signal and both a testing current sense signal and a testing voltage signal at the positive battery terminal wherein one of the testing current sense signal and the testing voltage signal are configured to be above an overcharge voltage level for the embedded battery.

10. The system of claim 1, further comprising:
a fuse array;
a reset logic circuit configured to turn off at least the discharging FET in response to receiving a reset signal from the reset terminal;
at least one testing fuse coupled with the fuse array and reset logic circuit and configured to move a test/reset switch from a testing position to a reset position upon receiving a testing fuse trimming signal and an end of a testing sequence of the embedded battery system.

11. A battery control system for an embedded battery, the system comprising:
a battery control circuit configured to be coupled with an embedded battery;
a discharging field effect transistor (FET) coupled with the battery control circuit;
a charging FET coupled with the battery control circuit;
a positive battery terminal coupled with the battery and a negative battery terminal coupled with the battery control circuit;
a reset terminal coupled with a reset circuit coupled with the battery control circuit;
wherein the reset circuit and battery control circuit are comprised in a single semiconductor chip coupled with the discharging FET and charging FET.

12. The system of claim 11, wherein no other FETs are included except the discharging FET and charging FET.

13. The system of claim 11, wherein the reset circuit is configured to turn off at least the discharging FET in response to receiving a reset signal from the reset terminal.

14. The system of claim 13, wherein a hardware switch configured to be pressed by a user is coupled with the reset terminal and configured to send a reset signal to the reset circuit when pressed by the user for a predetermined period of time.

15. The system of claim 13, wherein the reset circuit is configured to receive a reset signal via the reset terminal from a one of a load and a charger coupled to the battery control circuit.

16. The system of claim 13, wherein the reset circuit is configured to receive a reset signal via the reset terminal when an external power signal is applied to the reset terminal.

17. The system of claim 16, wherein the external power signal is sent from a power module integrated circuit (IC) coupled with the positive battery terminal and the negative battery terminal and wherein the reset circuit is configured to test the operation of the embedded battery through turning off at least the discharging FET.

18. The system of claim 11, further comprising a test switch and a reset switch, wherein when the test switch is closed, the reset terminal is configured to allow a testing system to test the embedded battery system, and when the reset switch is closed, the reset terminal is configured to receive reset signals and forward them to the reset circuit.

19. The system of claim 18, wherein the test switch is configured to close in response to receiving one of a testing current sense signal, a testing voltage signal and both a testing current sense signal and a testing voltage signal at the positive battery terminal wherein one of the testing current sense signal and the testing voltage signal are configured to be above an overcharge voltage level for the embedded battery.

20. The system of claim 11, further comprising:
a fuse array;
a reset logic circuit configured to turn off at least the discharging FET in response to receiving a reset signal from the reset terminal;
at least one testing fuse coupled with the fuse array and reset logic circuit and configured to move a test/reset switch from a testing position to a reset position upon receiving a testing fuse trimming signal and an end of a testing sequence of the embedded battery system.
